(19) United States
(12) Patent Application Publication
(10) Pub. No.: US 2017/0318336 A1
(43) Pub. Date: Nov. 2, 2017

(54) INFLUENCING CONTENT OR ACCESS TO CONTENT

(71) Applicant: MPORIUM GROUP PLC, London (GB)

(72) Inventors: Christopher Hackett, Manchester (GB); Tom Smith, London (GB); David Carlson, Manchester (GB); Ian Warford, Vancouver (CA); Nelius De Groot, London (GB)

(21) Appl. No.: 15/524,787

(22) PCT Filed: Nov. 9, 2015
(86) PCT No.: PCT/GB2015/053385

§ 371 Date: May 5, 2017

(30) Foreign Application Priority Data
Nov. 7, 2014 (GB) 1419834.5
Sep. 24, 2015 (GB) 1516944.4
Sep. 24, 2015 (GB) 1516946.9
Sep. 24, 2015 (GB) 1516947.7

(51) Int. Cl. H04N 21/44; H04N 21/81; H04N 21/4782; H04N 21/262; G06F 17/30; H04N 21/258; H04N 21/25; H04N 21/858; H04N 21/45

(52) U.S. Cl. CPC H04N 21/44008; H04N 21/8586; H04N 21/8133; H04N 21/4782; H04N 21/4532; G06F 17/30796; H04N 21/25891; H04N 21/25883; H04N 21/251; H04N 21/26283

(57) ABSTRACT

A method of influencing access to website, social media or mobile application content is described. The method comprises identifying the occurrence of an item of live or previously broadcast media content, identifying consumer Internet activity at the time of the occurrence of the item of media content, and identifying, from said detected consumer internet activity, a strategy to influence an Internet search function, social media site or mobile application to display selected information. Then, a subsequent broadcast of the item of media content is identified, and the identified strategy is triggered at the point the item occurs during the time of the identified subsequent broadcast.

The present invention relates to a method and apparatus for influencing content or access to content. Embodiments of the present invention relate to influencing access to website, social media or mobile application content, and to influencing website, social media or mobile application content.

It is common for consumers of media content to be using multiple devices at once. For example, a user may be watching a television programme while using a smartphone or tablet computer to surf the internet or interact with social media platforms such as Facebook. Sometimes a user may be motivated by television content (for example) to interact with their smartphone or tablet computer to find out more about something they saw on the television.

According to one aspect of the invention there is provided a method of influencing access to website, social media or mobile application content, comprising:

identifying the occurrence of an item of live or previously broadcast media content,

identifying consumer Internet activity at the time of the occurrence of the item of media content;

identifying, from said detected consumer internet activity, a strategy to influence an Internet search function, social media site or mobile application to display selected information;

identifying a subsequent broadcast of the item of media content; and

triggering the identified strategy at the point the item occurs during the time of the identified subsequent broadcast.

According to another aspect of the invention, there is provided a method of influencing website, social media or mobile application content, comprising:

identifying the occurrence of an item of live or previously broadcast media content;

identifying consumer Internet activity at the time of the occurrence of the item of media content,

identifying, from said detected consumer internet activity, a strategy to modify the content of a web site, web page, social media site or mobile application;

identifying a subsequent broadcast of the item of media content; and

triggering the identified modification to the content of the web site, web page, social media site or mobile application at the point the item occurs during the time of the identified subsequent broadcast.

Identifying the occurrence of an item of media content may comprise interrogating a scheduling database to determine a broadcast time for the media item. Alternatively, identifying the occurrence of an item of media content may comprise detecting the item of media content in a live media stream.

The method may comprise identifying trigger terms in the item of media content. In this case, identifying consumer activity may comprise identifying Internet searches conducted using the trigger terms, or using keywords associated with the trigger terms.

The media content may be, or have been broadcast in a television channel or video on demand stream. In this case, the trigger term may be detected in caption information and/or subtitle information associated with the television programme being broadcast or the video on demand stream. In one implementation, subtitle information is embedded within image data within the television broadcast signal or the video on demand stream, and the subtitle information is converted into text using optical character recognition.

The method may comprise generating and storing correlation data indicative of the impact of the item of media content on Internet searches conducted using the trigger words, or using keywords associated with the trigger terms. Information to be displayed as part of an Internet search function, social media site or mobile application may be selected in dependence on the correlation information.

Identifying the strategy may comprise specifying an Internet search function to be influenced based on trigger terms and/or key words determined to result in a level of consumer search activity which is greater than a threshold value

The Internet activity may be an Internet search carried out by a consumer, or more particularly, the number of Internet searches carried out by all consumers during a particular time window. Alternatively, the Internet activity may be consumer access to website, social media or mobile application content received over the Internet, again during a particular time window.

The selected information may be predetermined or dynamically generated, and may comprise a link to a web page, and/or images and text.

According to another aspect of the invention, there is provided an apparatus for influencing access to website, social media or application content, comprising:

a media content identifier, for identifying the occurrence of an item of live or previously broadcast media content;

an Internet activity identifier, for identifying consumer Internet activity at the time of the occurrence of the item of media content;

a strategy identifier, for identifying, from said detected consumer internet activity, a strategy to influence an Internet search function, social media site or application to display selected information;

a subsequent broadcast identifier, for identifying a subsequent broadcast of the item of media content; and

a strategy controller, for triggering the identified strategy at the point the item occurs during the time of the identified subsequent broadcast.

According to another aspect of the invention, there is provided an apparatus for influencing website, social media or application content, comprising:

a media content identifier, for identifying the occurrence of an item of live or previously broadcast media content,

an Internet activity identifier, for identifying consumer Internet activity at the time of the occurrence of the item of media content;

a strategy identifier, for identifying, from said detected consumer internet activity, a strategy to modify the content of a web site, web page, social media site or application;

a subsequent broadcaster identifier, for identifying a subsequent broadcast of the item of media content; and

a strategy controller, for triggering the identified modification to the content of the web site, web page, social media site or application at the point the item occurs during the time of the identified subsequent broadcast.

According to an aspect of the invention there is provided a method of monitoring the influence of media content on website traffic, comprising:

receiving a trigger term and associating the trigger term with a website;

monitoring traffic to the website;

detecting the trigger term in a media source; and

identifying and storing correlation data indicative of an impact of content in the media source on the level of traffic to the website, the content being indicated by the trigger term.

The media source may be one of a television channel, an on-demand video stream, a radio channel, a social media site, a news feed or a weather feed.

The trigger term may be detected in plural media sources.

The received trigger terms may be stored in a database.

The incidence of trigger terms within media sources may be stored in a database.

The correlation data may store a correlation between the occurrence of the trigger term in the media source with a level of traffic to the website at or during a predetermined period of time after the occurrence of the trigger term.

The media source may be a television channel or on demand video stream and the trigger term may be detected in caption information and/or subtitle information associated with the television programme being broadcast. Subtitle information may be embedded within image data within the television broadcast signal or video on demand signal, and in this case the subtitle information may be converted into text using optical character recognition.

Preferably, the correlation data is displayed.

According to another aspect of the invention, there is provided an apparatus for monitoring the influence of media content on website traffic, comprising:

a first database for receiving a trigger term and associating the trigger term with a website;

a traffic monitor, for monitoring traffic to the website;

a trigger term detector, for detecting the trigger term in a media source; and

a match detector, for identifying and storing into a second database correlation data indicative of content in the media source on the level of traffic to the website, the content being indicated by the trigger term.

According to an aspect of the invention there is provided a method of influencing access to website, social media or application content, comprising:

detecting an occurrence of a trigger term in a real time media source, and

influencing an Internet search function, social media site or application to display predetermined information in response to the detection.

The predetermined information may comprise a link to a web page. Further, the predetermined information may in some cases comprises images and/or text.

The web page may be modified in response to the detection.

The method may comprise maintaining a database of stored trigger terms associated with websites, matching the stored trigger terms against text extracted from the real time media source, and influencing the Internet search function or social media site to display a link to a web page of the associated website.

The Internet search function or social media site may be influenced by the occurrence of the trigger term for only a predetermined period of time.

The Internet search function or social media site may be influenced substantially immediately following the detection of the trigger term.

The Internet search function or social media site may be influenced following a predetermined delay from the detection of the trigger term.

One or more keywords may be associated with the trigger term, and the Internet search function may be influenced by triggering an adwords campaign based on the keywords associated with the trigger term.

The media source may be one of a television channel, an on-demand video stream, a radio channel, a social media site, a news feed or a weather feed.

Where the media source is a television channel or video on demand stream the trigger term may be detected in caption information and/or subtitle information associated with the television programme being broadcast or the video on demand stream. Where subtitle information is embedded within image data within the television broadcast signal or the video on demand stream, the subtitle information may be converted into text using optical character recognition.

According to another aspect of the invention there is provided an apparatus for influencing access to website, social media or application content, comprising:

a trigger term detector for detecting an occurrence of a trigger term in a real time media source; and

a controller for influencing an Internet search function, social media site or application to display predetermined information in response to the detection.

According to an aspect of the invention there is provided a method of influencing website content, comprising:

detecting an occurrence of a trigger term in a real time media source, and

modifying a web site or page in response to the detection.

The web site or page may be modified to display content related to the trigger term.

The method may comprise maintaining a database of stored trigger terms associated with web sites or pages, matching the stored trigger terms against text extracted from the real time media source, and modifying the associated web site or page.

The web site or page may be modified by the occurrence of the trigger term for only a predetermined period of time.

The web site or page may be influenced substantially immediately following the detection of the trigger term.

The web site or page may be modified following a predetermined delay from the detection of the trigger term.

The media source may be one of a television channel, an on-demand video stream, a radio channel, a social media site, a news feed or a weather feed.

Where the media source is a television channel or a video on demand stream, the trigger term may be detected in caption information and/or subtitle information associated with the television programme being broadcast or the video on demand stream.

Subtitle information may be embedded within image data within the television broadcast signal or the video on demand stream, and the subtitle information may be converted into text using optical character recognition.

According to another aspect of the invention, there is provided an apparatus for influencing website content, comprising.

a trigger detector for detecting an occurrence of a trigger term in a real time media source; and

a controller for modifying a web site or page in response to the detection.

To help understanding of the invention, a specific embodiment thereof will now be described by way of example and with reference to the accompanying drawings, in which:

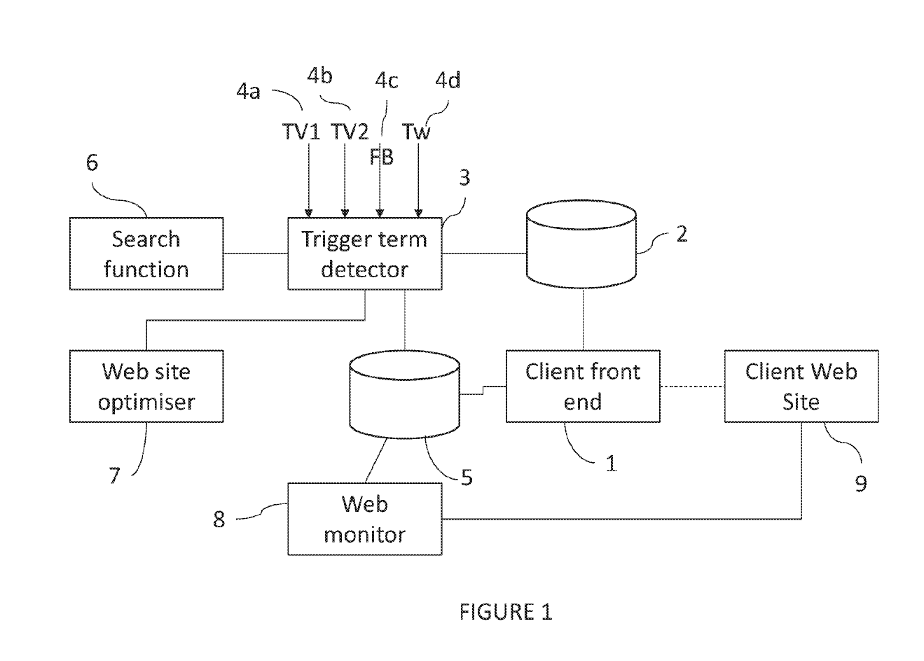

FIG. 1 schematically illustrates a system for monitoring media streams and influencing access to web pages based on that monitoring;

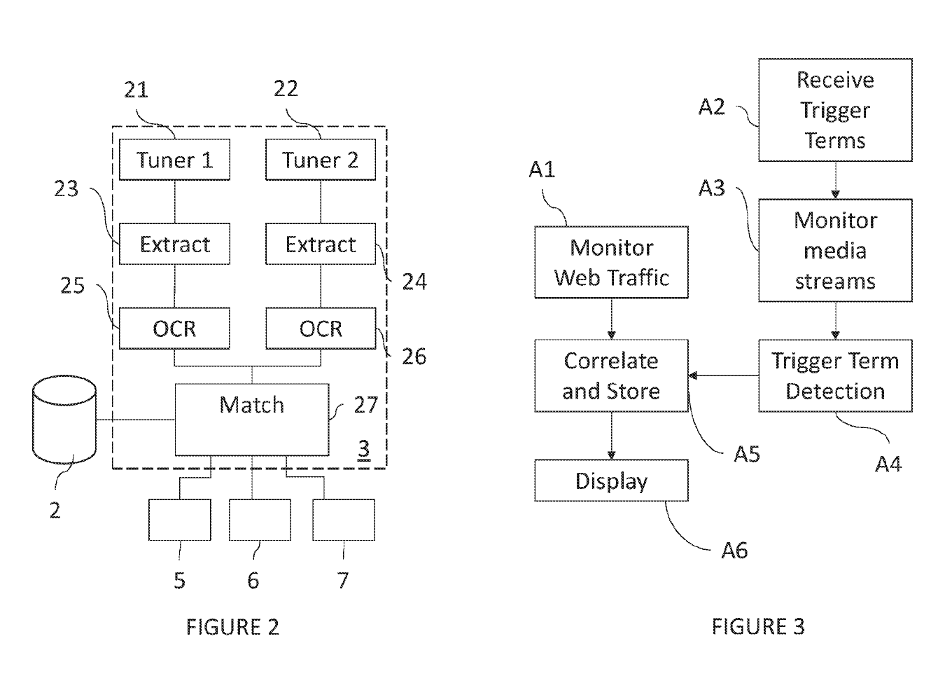

FIG. 2 schematically illustrates a system for detecting trigger terms in television captions;

FIG. 3 is a schematic flow diagram which illustrates how trigger terms can be used to correlate events occurring in a media stream with traffic to a website;

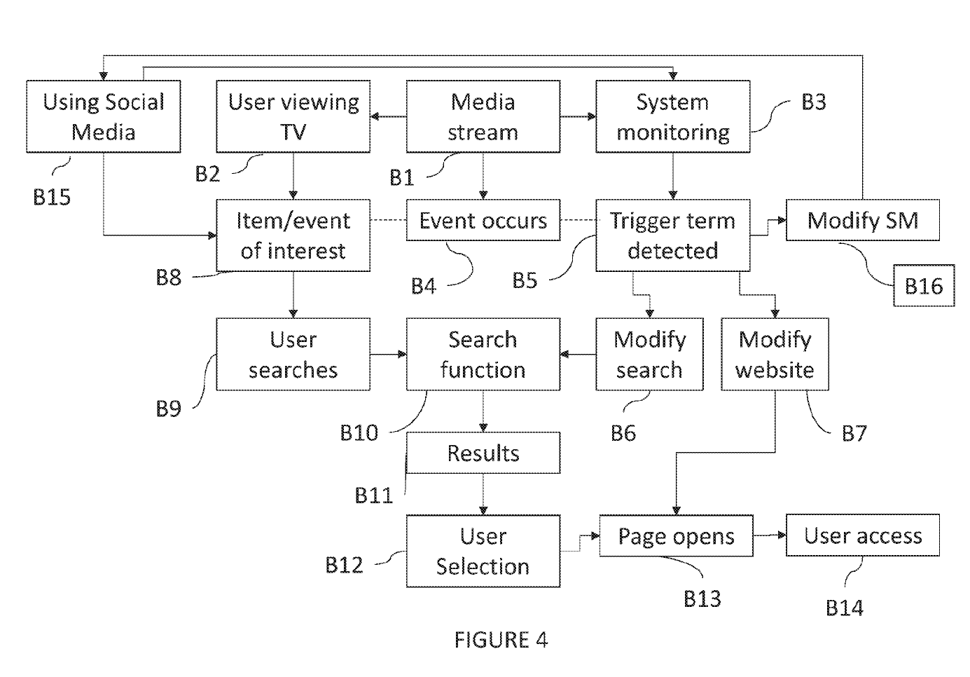

FIG. 4 is a schematic flow diagram which illustrates how a user is provided with enhanced access to relevant web page content based on trigger words within media streams;

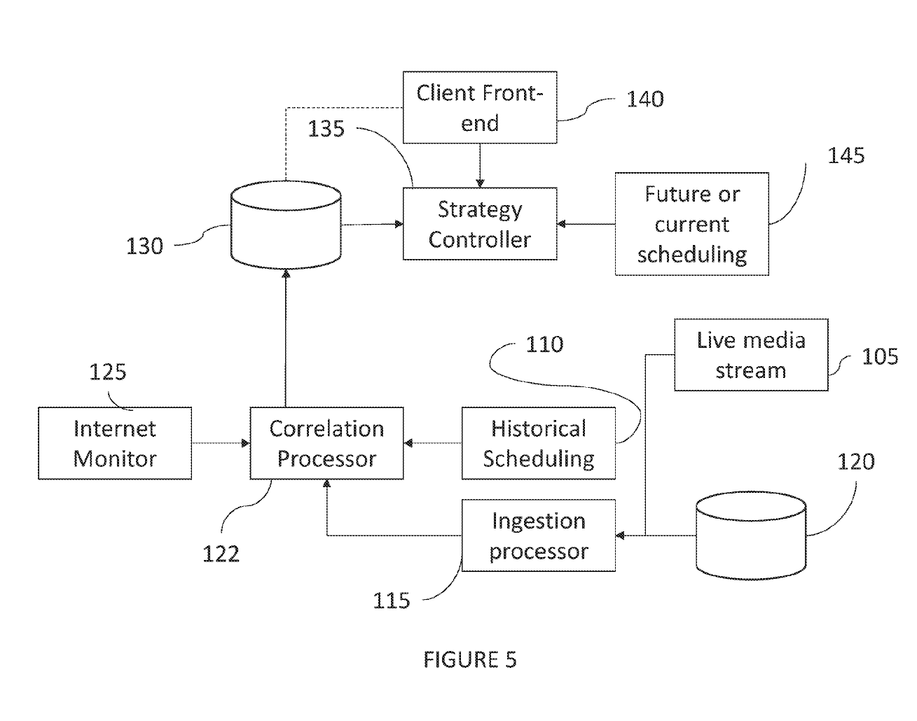

FIG. 5 schematically illustrates a system for identifying past consumer Internet search habits at the time of broadcast of media items; and

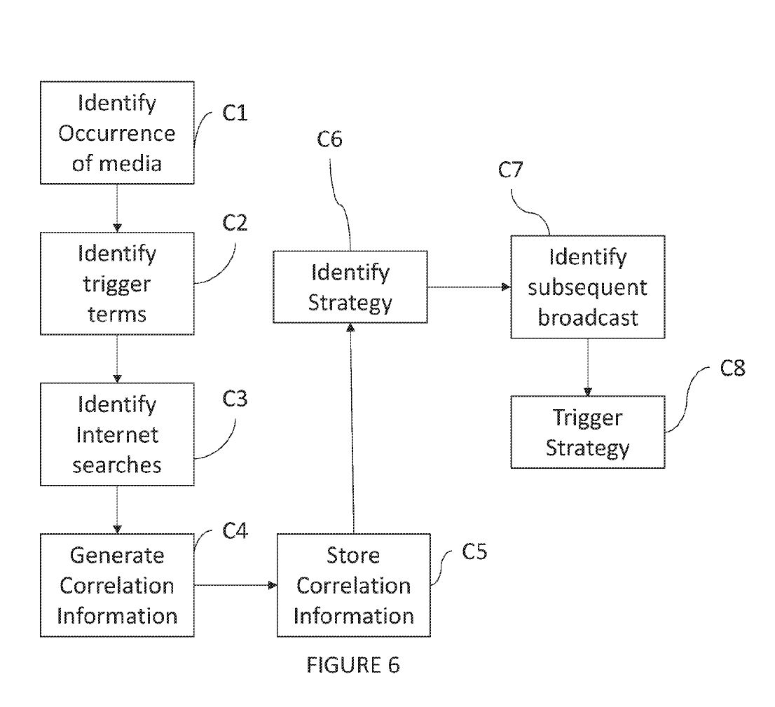

FIG. 6 is a schematic flow diagram of the operation of FIG. 5.

Referring to FIG. 1, a system for monitoring media streams and influencing Internet search functions, web pages, social media sites or applications (which might be mobile applications (or “apps”) running on portable electronic devices such as mobile phones, or software applications running on personal computers for example) based on those media streams is shown. The system comprises a client front end 1 which a user having an association with a particular web site or page 9 is able to use to enter trigger terms (words or phrases) which he considers to be contextually relevant to his web site 9, and in particular which he thinks the occurrence of which in a media stream might cause viewers of the media stream to be driven to his web site 9. For example, if the web site 9 is a merchant site selling clothes then trigger terms relating to types, styles or makes of clothing may be of interest, since viewers seeing the items or events to which these trigger terms relate might be interested in visiting the web site 9. The user may also enter rules which govern what happens when a trigger term is detected in one or more media streams. The rules may relate to how searches, web pages or other media streams should be influenced or modified if that trigger term is detected. The trigger terms are provided to a trigger term database 2, which can be expected to store large numbers of trigger terms associated with various different client users (and/or their associated web sites), and with various different rules. It will therefore be understood that the occurrence of a particular trigger word in a media stream may invoke a number of rules in relation to different client users and their websites, if that trigger word has been registered by multiple client users.

A trigger term detector 3 receives media data streams from multiple media sources 4 (four media sources are shown here—two TV channels 4a, 4b, a Facebook feed 4c and a Twitter feed 4d—but it will be appreciated that any number of TV channels, Internet feeds, radio or other real-time media sources such as news or weather feeds could be utilised) and detects when any of the trigger terms in the trigger term database 2 occur in any of media data streams. More particularly, the data from the media sources includes text which is compared against the trigger terms in the database 2. Certain types of media source, such as news or weather feeds, or social media feeds, are rich in text content, making it relatively straightforward to identify when trigger terms arise within those media sources. In other types of media source, such as television or radio, the media is less text based, making it more difficult to obtain trigger terms describing what is going on in the content. The example of television is discussed in some detail below. In the event that the trigger term detector 3 detects a trigger term in one of the media streams then this detection is recorded as a match in a match database 5. More particularly, the match database stores an indication that a detection of a particular trigger word has occurred, along with the media source originating the trigger word, and the time of the occurrence. It will be understood that the trigger term identified within the media stream is indicative of the content of the media stream.

In parallel with this, a web site monitor 8 monitors traffic to the client user's web site 9, and records this with respect to time. Again, it will be appreciated that the web site monitor 8 may in fact monitor traffic to a large number of client user web sites, and store traffic information in association with an identification of the web site or client user. The level of traffic to the web site 9 (or in the alternative an indication of an amount of increase in traffic to the web site 9) at or shortly after (usually within a few minutes) the detection of the trigger term is stored into the match database 5 in association with the record of occurrence of the trigger term. The user is able to view, via the client front end 1, how the occurrence of particular trigger terms (and thus the occurrence of the underlying content indicated by the trigger terms) influences the traffic to his web site 9. So, for example if the trigger term was “red dress”, detected in caption information from a television programme in which a celebrity is wearing a red dress, then this might result in large number of television viewers looking up red dresses on the Internet, which might in turn result in an uplift in the number of visitors to the users web site 9. The data stored in the match database may comprise a correlation between the occurrence of the trigger term in the media source with a level of traffic to the website at or during a predetermined period of time after the occurrence of the trigger term. The user may have a number of trigger terms registered at the trigger term database 2, and matches for each of these, and associated web traffic information, are stored at the match database 5. This enables the user to determine which trigger words are the most effective. The traffic information may not simply relate to the number of site visits, but might also relate (in the case of an e-commerce site) to the number of purchases made, or the conversion rate from hits to purchases. The traffic information might also track specific segments or demographics of visitors, such as sex, location, likes and dislikes and so on, making it possible to identify from the traffic information the types of viewers which are being driven to the site by particular trigger words.

The detection of a trigger word by the trigger term detector 3 can also initiate the optimisation of an Internet search function 6 that will cause or at least influence the search function to display predetermined information. For example, the predetermined information could be information relevant to the trigger word when appropriate keywords are used in the search (note that the keywords forming the basis of the internet search and the triggers words may be different). As a result, incidence of events within a media stream which are described by trigger words may be used to effectively tailor the information presented on a search results page in real time or near real time. This may give a user more efficient access to relevant information. Generally, the predetermined information will take the form of a link to the web site 9 (potentially in association with other information to assist a user in understanding the relevance of the web site 9 to their search) when invoked by a user performing a relevant search. In this way, media content from a media source, which may be the trigger for a viewer of that media source to perform an Internet search, can be used as a trigger to cause the web site 9 to appear prominently in an Internet search results page when the viewer performs a search (for example on Google). This could happen either immediately upon detection and processing of the trigger term, or in some cases a short time later. For example, it has been found that if a viewer sees a product which is of interest to them they will tend to search for it immediately, while if they are interested in an audio track or a video clip they may wait until the audio track or video clip has finished before performing an Internet search in relation to that item, or undertaking other consumer internet activity in relation to that item.

One possible implementation of this would be for the Internet search function 6 to trigger a Google Adwords campaign using suitable keywords, or increasing the bidding on an existing campaign. In this case, the web site 9 would be displayed on the search results page as an advertisement. In a similar manner, selected (predetermined or dynamically generated) information could be displayed on a social media site such as Facebook or LinkedIn in response to trigger terms appearing in a media stream. In either case, the search function or social media platform may only be influenced to display the selected information for a short period after the trigger term has occurred in a media stream. After this, the search function or social media platform may revert to default content or rules. The same principle may also be extended to content presented via mobile applications (apps), which may obtain, filter and display information obtained from the Internet. In other words, the information displayed via the app on a mobile device may be modified to include the selected information. This can be particularly useful for mobile devices, where the small screen size means that only a limited amount of information can be displayed at any one time.

Similarly, the detection of a trigger word by the trigger term detector 3 can also trigger a web site optimiser 7 to initiate the optimisation of the web site 9, to which a user will hopefully be directed via the search results page. In particular, the web site can be modified to relate to the context or subject of the trigger term. As a result, a user will find the content which they were interested in being readily available on the website, rather than needing to navigate deep into the website to find it. Returning to the “red dress” example, the detection of the trigger term “red dress” may cause the main page of the web site 9 to switching from displaying information about a grey jacket to displaying information about a red dress available for purchase through the web site 9. In this way, a person searching for a red dress will not only find it more easily through the web search function, but will also locate it more easily on the web site to which that person clicks through from the search results page. As with the search optimisation, the web site optimisation may occur substantially straightaway in response to the trigger terms, or might be delayed for a predetermined time. Also similarly with search optimisation, the web site may revert back to its original state after a predetermined period of time has passed and the modified content has thus become less relevant.

Referring back to the match database, it will be appreciated that influencing the prominence of the user's web site 9 and the immediate availability of content relevant to the trigger term at the web site 9 could be expected to increase the amount of traffic to the web site 9. As a result, the match database 5 is able to provide a good indication of how much of an enhancement to web site traffic is being achieved by way of influencing search results and web page optimisation. Accordingly, client users are able to identify which trigger words are providing maximum impact in driving viewers to their website.

In one example, at least some of the media sources are television channels. Referring to FIG. 2, functional blocks for detecting trigger terms within these television channels are shown. In FIG. 2, two tuners 21, 22 are provided, each for receiving a respective television channel and for decoding and outputting a sequence of image frames forming a video image. To the output of each turner is a respective subtitle extraction block 23, 24 for extracting a portion of each image frame which corresponds to a subtitle or caption location. The output of each extraction block 23, 24 is a respective optical character recognition block 25, 26 which is able to determine the text included within the subtitle and output it to a matching unit 27, which matches the recognised text against trigger terms stored in the database 2 shown in FIG. 1. The elements 21-27 correspond to the trigger term detector 3 of FIG. 1. In the case of a match, the match database 5, search function 6 and web site optimiser 7 are all informed of the detection, as described above in relation to FIG. 1. The FIG. 2 implementation may be important for territories, such as the United Kingdom, where subtitle data is embedded directly into the image. Where the subtitle data is available as text within the data stream (such as for video signals in the US) then a simplified trigger term detector can be used, omitting the requirement to perform optical character recognition.

Referring to FIG. 3, a method of monitoring the influence of media content on website traffic is shown in the form of a flow diagram. At a step A1 web traffic (for example the number of visits) to a web site is monitored. At a step A2, a client enters trigger terms they deem relevant to their website. At a step A3, media streams are monitored with respect to those trigger terms, and if at a step A4 a trigger term is detected in a media stream then that occurrence is correlated with the monitored website traffic and stored in a database at a step A5. The correlated and stored data, or analytics conducted on that data, is then displayed at a step A6.

Referring to FIG. 4, a method of influencing access to website content is shown in the form of a flow diagram. At a step B1, a media stream, in this case a television channel, is playing. At a step B2, a user is viewing the television channel. In parallel with the step B2, the system described above, and in particular the trigger term detector 3, is monitoring the television channel for trigger words. At a step B4, a to particular event occurs within the television content which both gives rise to a trigger word being detected at a step B5, and is also (in parallel) of interest to a user at a step B8. In response to the detection of the trigger term, a search function relating to the event is modified at a step B6, and a website bearing content relevant to the event is also modified. The steps B5, B6 and B7 occur very quickly, typically in less than a minute. Accordingly, by the time the user initiates a web search at a step B9, the modifications have already been made, resulting in a search function carried out at a step B10 being the one modified at the step B6. Results of the modified search function are presented to the user at a step B11. Based on the results, the user may select the website at a step B12, which by this time will have been modified at the step B7, and thus when it opens the content of the website will have been tailored in view of the event, and in particular in view of the detection of the trigger term. The user is therefore able to access the website content at a step B14, without needing to navigate through the website to find the information which he was looking for based on the event witnessed on the television channel. In parallel with the above steps, the user is also using social media—for example Facebook or Twitter. These represent media streams in themselves, which are monitored by the step B3 and which represent events which might trigger the user (at the step B8) to perform a web search. Also though, the social media site experienced by the user may itself be controlled, at a step B16, in response to the detection of a trigger term, so as to place specific selected context relevant content where it can be readily found by the user.

The invention is not intended to be restricted to the details of the above described embodiment. For instance, while the above explanations are based on a search function, social media platform, web site or mobile application being influenced based on a single trigger term, the triggering could instead occur in response to a certain number of instances of a trigger word occurring within a predetermined time window, or on particular ones of the media streams, or could instead occur in response to a certain combination of different trigger words occurring within a predetermined time window or on particular ones of the media streams.

It will be appreciated that the same item of media content, for example a film or a TV show, may be repeated a number of times on the same or a different channel, or in the same or a different country. A repeat of an item of media content is likely to have much the same influence on consumer behaviour in accessing Internet content as did the original broadcast of that media item. Accordingly, knowledge of consumer Internet activity resulting from the first (or each previous) broadcast may be used to either improve access to information which the viewer of a repeat of that media item is likely to find interesting (for example by influencing an Internet search function, or a social media site, or a mobile application which that consumer is likely to use while the repeat of the media item is ongoing to display selected information), or by influencing the information itself (for example by modifying a particular web page or web site, or social media site or mobile application content), again while the repeat of the media item is ongoing.

Referring to FIG. 5, a system for identifying past consumer Internet search habits at the time of broadcast of media items is schematically illustrated. In FIG. 5, a correlation processor 122 is able to identify a time of broadcast of a particular media item—which might be a particular movie or TV show—from historical scheduling information 110. An ingestion processor 115 is also able to identify trigger terms associated with media items stored in a media database 120. Techniques for identifying trigger terms associated with media items are discussed in relation to earlier figures, and may be used here. An Internet monitor 125 is able to identify consumer Internet activity at the time of broadcast of the media item. This Internet activity may be the amount of Internet search activity in relation to one of the trigger terms identified by the ingestion processor 115, or to key words associated with one of the trigger terms. Such Internet search activity may be obtained from Google Analytics for example, and may comprise an indication of the number of times a particular search word or phrase has been used within a particular time window. It will be understood that by looking at a time window associated with the identified time of broadcast of the media item, an indication of the impact of the broadcast of that media item on consumer Internet activity can be inferred. Preferably, the “background” level of consumer Internet activity in relation to that search word or phrase can also be identified, and an increase in consumer Internet activity calculated. The background level might be single number with the averaged number of searches per unit time, or might be a function of time of day. For example, if a background level of search for a particular term is 800 searches within a given 10 minute time window during the day (for example between 17:00 and 17:10), based on historical figures, then if 2400 searches are made during that time window when a particular media item was being broadcast at that time, it is reasonable to assume that the broadcast of the media item has influenced consumer interest in making that search. In this case the impact of the media item on the Internet activity may be expressed as an uplift (200%) on the expected background level of search. An identity of the media item, the trigger words associated with that media item, and the Internet activity associated with the media item (and in particular with the trigger words) are then correlated together and stored as correlation information in a correlation database 130.

It will be appreciated that a similar technique could be used in real time rather than looking at historical scheduling information and Internet search activity. This is shown in FIG. 5 by the live media stream 105, which is ingested by the ingestion processor 115 in this case (to extract trigger words) instead of stored media in the database 120. Internet activity in relation to the trigger terms (or related key words) is identified by the Internet monitor 125 in the manner described above. In this case, there is no need to identify the time of broadcast from scheduling information, since the time in question is the current time. Similarly to above, the identity of the media item, the Internet activity associated with that media item (and in particular with the trigger words) are then correlated together and stored as correlation information in the correlation database 130.

It will be appreciated that the resulting content of the correlation database 130 provides a resource of how particular media items influence Internet activity. A client front end 140 may be able to access a view of this information to assist them in identifying a strategy for influencing a future search, or a social media site, or a mobile application, to display selected information. In particular, the user may be able to identify (either automatically based on an algorithm, or using manual intervention), selected information which is likely to be of interest to consumers in view of the searches which they made. A user interface may be provided to enable a user to set up one or more strategies to be triggered the next time that media item is broadcast. The strategy might include upping a bid for a keyword within an advertising campaign such as Google AdWords (which will influence a search to display selected information), it might be placement of product on a website at a to particular time (that is, modifying the content of a website to include content which is contextually relevant to a particular media item being broadcast), it might be launching a promotion in relation to that product, or many other actions. The selected information may (as per above) be a link to a particular web page, and may include text and or image data. In addition to this specific information regarding the relationship between a particular media item (and potentially a particular time segment within a media item) and Internet activity, the correlation information also associates together particular trigger terms with particular Internet search statistics. This association represents the likely impact of media content containing a particular trigger term giving rise to particular consumer searches (or other Internet activity—as discussed below). This enables trigger terms to be evaluated as to how valuable they are likely to be as triggers for influencing access to website, social media or mobile application content, or for modifying website, social media or mobile application content. A trigger term which is associated with only a modest increase in Internet traffic is likely to be a less useful trigger term than one which is associated with a larger increase in Internet traffic. By utilising historic scheduling information and ingesting stored media it is possible to build up a detailed picture of the value of particular trigger words, which can be used to infer the likely impact of future media content (containing those trigger words) on consumer Internet activity. The most promising trigger words can therefore be used to trigger the influencing of access to and/or the modification of Internet-related content in the manner described above with reference to FIGS. 1 to 4. It will be understood that the correlation between a media item and Internet activity, or between trigger words and Internet activity, can be improved by looking at each repeat of that media item and the impact it has on web searches, rather than just relying on data from the first broadcast of that media item.

Instead of using consumer search statistics, the Internet activity may be based on detected consumer access to website, social media or mobile application content received over the Internet. This may require reporting by software installed on user devices (for example a browser plug-in), or reporting from web sites, social media platforms or mobile applications.

A strategy controller 135 is able to formulate a strategy to influence an Internet search function, social media site or mobile application to display selected information, and/or a strategy to modify the content of a web site, web page, social media site or mobile application. The strategy is based on the correlation information, and may include identifying suitable content to be displayed in an Internet search, or on a social media site, or via a mobile application, or modifications to be made to a web page or web site, or to a social media output stream, or to information provided to a user through a mobile application. The selected information and/or modifications may be predetermined information and/or modifications previously associated with trigger terms. In this case, the formulation of a strategy involves (a) determining which trigger words associated with the media item have given rise to a substantial increase in Internet activity, and (b) identifying what predetermined information (for display) or modification is associated with those trigger words. More generally, the selected information may be predetermined or dynamically generated. Future or current scheduling information 145 may be made available to the strategy controller 135 in order to enable the strategy controller 135 to trigger the strategy at an appropriate time, and in particular at a time when the media item is being broadcast again.

Referring to FIG. 6, a schematic flow diagram illustrating the operation of the system of FIG. 5 is provided. At a step C1, the occurrence of an item of media content is identified from historic scheduling information. At a step C2, trigger terms within or associated with the item of media content are identified. This may be achieved, as described above, by obtaining the media item from a content database, and processing it to extract trigger terms as discussed above in relation to FIGS. 2 and 3. At a step C3, a volume of Internet searches made using the trigger terms, or made using keywords associated with those trigger terms, at the time of the broadcast, are identified. An activity metric based on the identified volume as compared with a normal (background) volume of Internet searches made using the same search terms can be evaluated. At a step C4, correlation information can be generated which associates together the activity metric with the media item and/or with a time point or window within the media item and/or with the trigger words. At a step C5, the correlation information is stored in a database. At a step C6, a strategy to influence an Internet search function, social media site or mobile application to display selected information, and/or a strategy to modify the content of a web site, web page, social media site or mobile application is determined. Identifying the strategy may involve specifying an Internet search function to be influenced based on trigger terms and/or key words determined to result in a level of consumer search activity (for example the activity metric) which is greater than a threshold value. In one example, a Google AdWords campaign (defining selected content to be displayed in response to a particular search) based on those trigger words/key words may form part of the strategy. At a step C7, a future broadcast time for the media item is identified, and then at a step C8 the determined strategy is triggered at the time of broadcast of the media item. It will be understood that the strategy may be triggered at a particular time, and for a particular period, during the broadcast, rather than being triggered at the start and persisting throughout the broadcast. Returning to the step C7, it will be appreciated that in one approach the identification of the future broadcast may simply be achieved by monitoring media sources and detecting the occurrence of the media item (for example based on metadata received with the broadcast of the media item), and in which case the step C8 may be triggered in response to such detection.

1. A method of presenting selected information in an Internet search function, website, web page, social media site or application, comprising:
identifying an occurrence of an item of live or previously broadcast media content;
identifying a trigger term in the item of media content;
identifying consumer Internet activity at a time of the occurrence of the item of media content, wherein the consumer Internet activity comprises the trigger term or a keyword associated with the trigger term;
identifying, from the consumer Internet activity, a strategy to present selected information in an Internet search function, website, web page, social media site or application;
identifying a subsequent broadcast of the item of media content; and
triggering the strategy at a time the item of media content occurs during the subsequent broadcast.

2. (canceled)

3. The method according to claim 1, wherein identifying the occurrence of the item of media content comprises interrogating a scheduling database to determine a broadcast time for the item of media content.

4. The method according to claim 1, wherein identifying the occurrence of the item of media content comprises detecting the item of media content in a live media stream.

5. (canceled)

6. The method according to claim 1, wherein the item of media content is or has been broadcast in a television broadcast signal or video on demand stream and identifying the trigger term comprises detecting the trigger term in at least one of caption information and subtitle information associated with the television programme being broadcast or the video on demand stream.

7. The method according to claim 6, wherein subtitle information is embedded within image data within the television broadcast signal or the video on demand stream, and wherein identifying the trigger term comprises converting the subtitle information into text using optical character recognition.

8. The method according to claim 1, comprising generating and storing correlation data indicative of an impact of the item of media content on Internet searches conducted using the trigger term or the keyword, and comprising selecting the selected information in dependence on the correlation data.

9. (canceled)

10. The method according to claim 1, wherein identifying the strategy comprises specifying an Internet search function to be influenced based on the trigger term or the keyword.

11-13. (canceled)

14. The method according to claim 1, wherein the selected information comprises at least one of a link to a web page, an image, and text.

15. (canceled)

16. An apparatus for presenting selected information in an Internet search function, website, web page, social media site or application, comprising:
a media content identifier, for identifying an occurrence of an item of live or previously broadcast media content, and for identifying a trigger term in the item of media content;
an Internet activity identifier, for identifying consumer Internet activity at a time of the occurrence of the item of media content, wherein the consumer Internet activity comprises the trigger term or a keyword associated with the trigger term;
a strategy identifier, for identifying, from the consumer Internet activity, a strategy to present selected information in an Internet search function, website, web page, social media site or application;
a subsequent broadcast identifier, for identifying a subsequent broadcast of the item of media content; and
a strategy controller, for triggering the strategy at a time the item of media content occurs during the subsequent broadcast.

17-27. (canceled)

28. A method of presenting predetermined information in an Internet search function, website, web page, social media site or application, comprising:
detecting an occurrence of a trigger term in a real time media source; and
influencing an Internet search function, website, web page, social media site or application to present predetermined information in response to the detecting the occurrence of the trigger term.

29. The method according to claim 28, wherein the predetermined information comprises at least one of a link to a web page, an image, and text.

30-31. (canceled)

32. The method according to claim 29, comprising maintaining a database of stored trigger terms associated with websites, matching the stored trigger terms against text extracted from the real time media source to identify a triggered website, and influencing the Internet search function, website, web page, social media site or application to present a link to a web page of the triggered website.

33. The method according to claim 28, wherein influencing comprises influencing the Internet search function, website, web page, social media site or application to present predetermined information for only a predetermined period of time.

34. The method according to claim 28, wherein influencing is performed substantially immediately following detecting the occurrence of the trigger term.

35. The method according to claim 28, wherein influencing is performed following a predetermined delay detecting the occurrence of the trigger term.

36. The method according to claim 28, wherein one or more keywords are associated with the trigger term, and wherein influencing comprises triggering an adwords campaign based on keywords associated with the trigger term.

37. The method according to claim 28, wherein the media source is one of a television channel, an on-demand video stream, a radio channel, a social media site, a news feed or a weather feed.

38. The method according to claim 28, wherein the media source is a television broadcast signal or video on demand stream and detecting comprises detecting the trigger term in at least one of caption information and subtitle information associated with the television programme being broadcast or the video on demand stream.

39. The method according to claim 38, wherein subtitle information is embedded within image data within the television broadcast signal or the video on demand stream, and wherein detecting comprises converting the subtitle information into text using optical character recognition.

40-41. (canceled)

42. The method according to claim 28, wherein influencing comprises modifying the Internet search function, website, web page, social media site or application to present content related to the trigger term.

43-51. (canceled)
